(19) United States
(12) Patent Application Publication
(10) Pub. No.: US 2009/0098853 A1
(43) Pub. Date: Apr. 16, 2009

(54) METHOD, APPARATUS AND COMPUTER PROGRAM PRODUCT FOR PROVISION OF GROUPED IDENTITY INFORMATION

(76) Inventors: Jari Mutikainen, Lepsama (FI); Miikka Poikselka, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/235,007

(22) Filed: Sep. 22, 2008

Related U.S. Application Data
(60) Provisional application No. 60/980,027, filed on Oct. 15, 2007.

(51) Int. Cl. H04M 11/00

(52) U.S. Cl. 455/406

(57) ABSTRACT

An apparatus for provision of grouped identity information may include a processor. The processor may be configured to receive an indication of a subscription for a registration event package, access information related to the subscription and indicative of identities and corresponding services supported for each of the identities, communicate group identity information to a terminal, and enable selection of a particular identity associated with initiating a particular service.

### CROSS REFERENCE TO RELATED APPLICATION

This application claims the benefit of U.S. Provisional Application No. 60/980,027, filed Oct. 15, 2007, the contents of which are incorporated herein in their entirety.

### FIELD OF THE INVENTION

Embodiments of the present invention relate generally to communication technology and, more particularly, relate to an apparatus, method and a computer program product for providing grouped identity information, for example, within an Internet Protocol (IP) Multimedia Subsystem (IMS).

### BACKGROUND OF THE INVENTION

The IMS is an architectural framework for delivering IP multimedia to users in a mobile or fixed environment. In this regard, IMS has been designed by the 3rd Generation Partnership Project (3GPP) to enable, for example, the delivery of Internet services over General Packet Radio Service (GPRS) and other networks such as wireless local area networks (WLAN), code division multiple access (CDMA) 2000, fixed line networks and the like. Currently, several IMS services are being standardized by 3GPP and the Open Mobile Alliance (OMA).

End users of IMS typically may have multiple user identities which could be used simultaneously as described, for example, in a 3GPP publication TS 23.228. The end users may also have multiple devices within a single subscription. Accordingly, various different devices and/or identities could be associated with a single subscription. When a subscriber, which may be an entity comprising one or more users, subscribes to a service, an IMS subscription associated with the subscriber may be created. The IMS subscription may be associated with one or more private user identities, each of which may be associated with one or more public user identities (some of which may be shared between different private user identities). The public user identities, which may be used to identify a user requesting communication with other users, may be associated with different service profiles. A service profile is a collection of service and user related data that is defined and maintained in a home subscriber server (HSS). The private user identities are assigned by the home network operator and are used for registration, authorization, administration, accounting and other like purposes. The private user identity may take the form of, for example, a Network Access Identifier (NAI), which may contain an international mobile subscriber identity (IMSI).

TS 24.229 defines a registration event package. An end user device or terminal (e.g., a user equipment (UE)) may subscribe to the registration event package after a successful registration. An application server (AS), which may be a server providing a value added IMS service, may reside either in the user's home network or in another network. The AS may also subscribe to a registration event package. A serving call session control function (S-CSCF), which may be in communication with the AS, the UE and the HSS, may receive profile information from the HSS. The S-CSCF may also notify the UE and AS of changes in registration status using the registration event package. The registration event package may include information such as a list of all public user identities associated with a particular user of which the S-CSCF is aware, a registration status for each public user identity (terminated or active), for each public user identity, a list of contact addresses that have been or are registered to the identity, and/or a registration status of each contact address (terminated or active).

The registration event package enables the UE to learn, e.g., after IMS registration, the other registered public user identities of a particular subscriber and other UEs that have been registered under the corresponding subscription. The UE may use this information to register for another public user identity, and also to select one of the public user identities for inclusion in an IMS session the UE initiates, such that the selected identity is the preferred identity for the initiated session. A proxy call session control function (P-CSCF), which may be in communication with the S-CSCF and the UE, may set the selected identity as the asserted identity for the initiated IMS session and the S-CSCF may execute the service profile for the asserted identity. Accordingly, the UE may select which identity's service profile gets executed when the UE initiates an IMS session.

The AS may subscribe to the registration event package, as described above, in order to learn the registration status of the particular subscriber. The AS may also receive notice of a certain public user identity as being the asserted identity for the initiated IMS session when the S-CSCF executes services for the IMS session.

The fact that multiple identities may be associated with a particular subscription should be appreciated from the description above. Furthermore, certain identities may be considered aliases of other identities. In this regard, a public user identity is an alias of another public user identity if both identities belong to the same implicit registration set, are linked to the same service profile and have the same service data configured for each and every service.

Many recent changes with respect to IMS have occurred. In this regard, TS 23.228 requires that the UE and AS must be able to learn which public user identities are aliases to each other. TS 24.229 will be assumed to use the registration event package to carry the alias relationship to the UE and the AS. A recent IETF draft (draft-jarauz-sipping-grouping-reg-event-01) now defines that public user identities in the registration event package may be grouped into groups. Each group may then be considered to represent one set of alias identities, i.e., the identities under the same group are aliases to each other. A communication service identity framework has also been defined in TS 23.228. The framework defines an ICSI (IMS Communication Service Identifier) that may be used to indicate the requested service in the initial request of the IMS session. The ICSI may be, for example, a uniform resource name (URN). The IMS (S-CSCF) may use the received ICSI value to determine whether the subscriber is authorized for the requested IMS service. For this reason a list of ICSI values may be included as part of the subscriber profile in order to enable the S-CSCF to learn from the HSS (e.g., via the Cx reference point) the services that the served user is allowed to use. The S-CSCF may receive this information from the HSS as part of regular subscriber profile download during the registration phase.

However, despite the changes described above, there is currently no link between IMS communication services and public user identities from the perspective of the UE and the AS. Accordingly, the UE cannot currently learn the IMS communication services that are provisioned for a particular public user identity. Since the UE cannot learn the IMS communication service provisioned for a particular public user identity, the UE may select an identity that does not support the service that the UE tries to initiate. In such a situation, the S-CSCF may attempt to execute the services for the service profile that does not include the service, but the session will be rejected or, even if the S-CSCF does not reject the session, the AS that implements the service will not be contacted for the session and the service initiation may fail.

Accordingly, it may be desirable to improve information sharing between entities of the IMS in order to obviate or reduce the impact of at least some of the disadvantages described above.

### BRIEF SUMMARY OF THE INVENTION

A method, apparatus and computer program product are therefore provided that enable provision of group identity information and corresponding supported services for each group to the UE and/or the AS. In other words, embodiments of the present invention may provide a link between communication services and user identities that may be provided to the UE and/or AS. Accordingly, the end user, UE or the application in the UE that implements the service, may select the public user identity under the corresponding subscription that supports a service to be initiated when the UE initiates an IMS session for the service to be initiated. Additionally, the AS may benefit from such a link between communication services and user identities. In this regard, the AS that implements a particular service, may be able to get information regarding which public user identities of the served subscriber support the particular service. In this way, the AS could, for example, ensure that the service settings for the identities that provide the particular service remain the same as specified by the user for the corresponding identity. The AS may also be able to execute the service for all public user identities in the identity group or set (alias set) even if the AS has stored the service settings only for one of the identities. Accordingly, there may be no need to maintain the alias set also in the AS, since the AS may rely on information stored in the HSS.

In an exemplary embodiment, a method for provision of grouped identity information may include receiving an indication of a subscription for a registration event package, accessing information related to the subscription and indicative of identities and corresponding services supported for each of the identities, communicating group identity information to a terminal, and enabling selection of a particular identity associated with initiating a particular service.

In another exemplary embodiment, a computer program product for provision of grouped identity information may include at least one computer-readable storage medium. The computer-readable storage medium may have computer-readable program code portions stored therein. The computer-readable program code portions may include first program code instructions, second program code instructions, third program code instructions and fourth program code instructions. The first program code instructions may be for receiving an indication of a subscription for a registration event package. The second program code instructions may be for accessing information related to the subscription and indicative of identities and corresponding services supported for each of the identities. The third program code instructions may be for communicating group identity information to a terminal. The fourth program code instructions may be for enabling selection of a particular identity associated with initiating a particular service.

In another exemplary embodiment, an apparatus for provision of grouped identity information is provided. The apparatus may include a processor configured to receive an indication of a subscription for a registration event package, access information related to the subscription and indicative of identities and corresponding services supported for each of the identities, communicate group identity information to a terminal, and enable selection of a particular identity associated with initiating a particular service.

In an alternative exemplary embodiment, a method for provision of grouped identity information may include receiving an indication of a subscription for a registration event package, accessing information related to the subscription and indicative of identities and corresponding services supported for each of the identities, communicating group identity information to a network device, and enabling the provision of functionality based on predefined criteria associated with a particular identity.

In another exemplary embodiment, a computer program product for provision of grouped identity information may include at least one computer-readable storage medium. The computer-readable storage medium may have computer-readable program code portions stored therein. The computer-readable program code portions may include first program code instructions, second program code instructions, third program code instructions and fourth program code instructions. The first program code instructions may be for receiving an indication of a subscription for a registration event package. The second program code instructions may be for accessing information related to the subscription and indicative of identities and corresponding services supported for each of the identities. The third program code instructions may be for communicating group identity information to a network device. The fourth program code instructions may be for enabling the provision of functionality based on predefined criteria associated with a particular identity.

In another exemplary embodiment, an apparatus for provision of grouped identity information is provided. The apparatus may include a processor configured to receive an indication of a subscription for a registration event package, access information related to the subscription and indicative of identities and corresponding services supported for each of the identities, communicate group identity information to a network device, and enable the provision of functionality based on predefined criteria associated with a particular identity.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a network device according to an exemplary embodiment of the present invention;

FIG. 3 is a schematic block diagram of an IMS according to an exemplary embodiment of the present invention;

FIG. 4 is a schematic diagram showing a communication flow within the exemplary IMS of FIG. 3 according to an exemplary embodiment of the present invention; and

FIG. 5 is a flowchart according to an exemplary method of providing an improved access class barring rotation according to an exemplary embodiment of the present invention.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

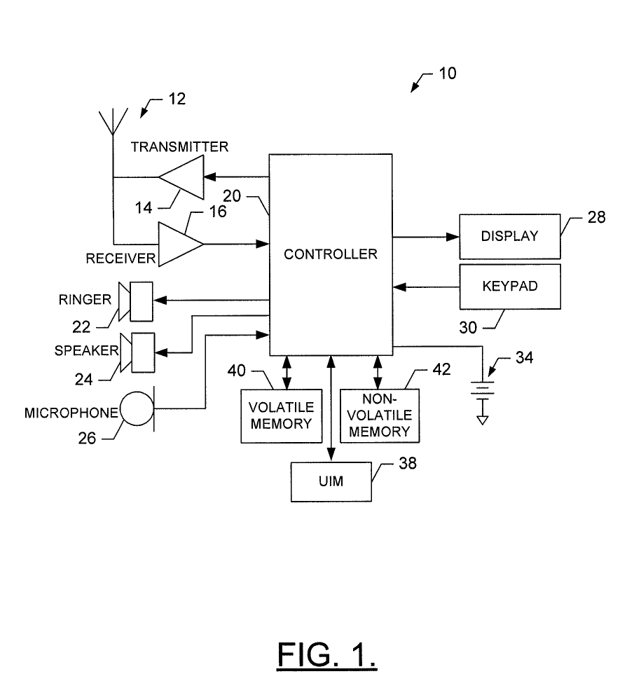

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, may readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention may be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, LTE or E-UTRAN, with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The non-volatile memory 42 may additionally or alternatively comprise an EEPROM, flash memory or the like, such as that available from the SanDisk Corporation of Sunnyvale, Calif., or Lexar Media Inc. of Fremont, Calif. The memories may store any of a number of pieces of information, and data, used by the mobile terminal 10 to implement the functions of the mobile terminal 10. For example, the memories may include an identifier, such as an international mobile equipment identification (IMEI) code, capable of uniquely identifying the mobile terminal 10.

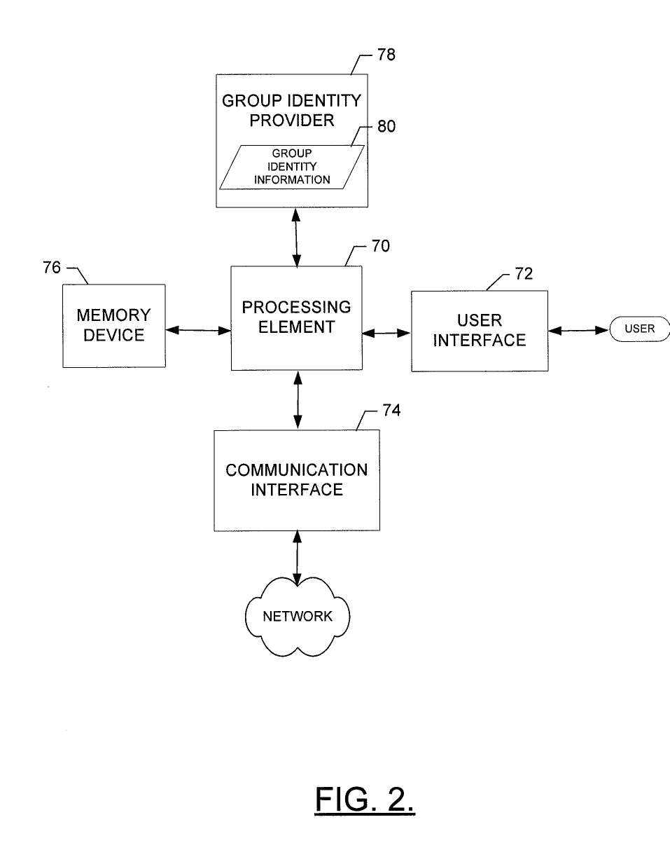

FIG. 2 is a schematic block diagram of a network device according to an exemplary embodiment of the present invention. The network device of FIG. 2 may be, for example, a server, computer or other network device configured to execute functions within the network on the basis of hardware and/or software implemented control. However, it should be noted that the apparatus of FIG. 2, may also be employed on a variety of other devices, both mobile and fixed, and therefore, embodiments of the present invention should not be limited to application on devices such as servers. It should also be noted that while FIG. 2 illustrates one example of a configuration of an apparatus that may be capable of provision of group identity information, numerous other configurations may also be used to implement embodiments of the present invention.

Referring now to FIG. 2, an illustration of an apparatus, such as a network device, that would benefit from embodiments of the present invention is provided. The apparatus may include or otherwise be in communication with a processing element 70, a user interface 72, a communication interface 74 and a memory device 76. The memory device 76 may include, for example, volatile and/or non-volatile memory. The memory device 76 may be configured to store information, data, applications, instructions or the like for enabling the apparatus to carry out various functions in accordance with exemplary embodiments of the present invention. For example, the memory device 76 could be configured to buffer input data for processing by the processing element 70. Additionally or alternatively, the memory device 76 could be configured to store instructions for execution by the processing element 70. As yet another alternative, the memory device 76 may be one of a plurality of databases that store information.

The processing element 70 may be embodied in a number of different ways. For example, the processing element 70 may be embodied as a processor, a coprocessor, a controller or various other processing means or devices including integrated circuits such as, for example, an ASIC (application specific integrated circuit), an FPGA (field programmable gate array, and/or a hardware accelerator. In an exemplary embodiment, the processing element 70 may be configured to execute instructions stored in the memory device 76 or otherwise accessible to the processing element 70. Meanwhile, the communication interface 74 may be embodied as any device or means embodied in either hardware, software, or a combination of hardware and software that is configured to receive and/or transmit data from/to a network and/or any other device or module in communication with the apparatus. In this regard, the communication interface 74 may include, for example, an antenna and supporting hardware and/or software for enabling communications with a wireless communication network. However, wired communications may also be supported.

The user interface 72 may be an optional element. In this regard, if employed, the user interface 72 may be in communication with the processing element 70 to receive an indication of a user input at the user interface 72 and/or to provide an audible, visual, mechanical or other output to the user. As such, the user interface 72 may include, for example, a keyboard, a mouse, a joystick, a touch screen display, a conventional display, a microphone, a speaker, or other input/output mechanisms. In an exemplary embodiment in which the apparatus is embodied as a server, the user interface 72 may be limited, or eliminated.

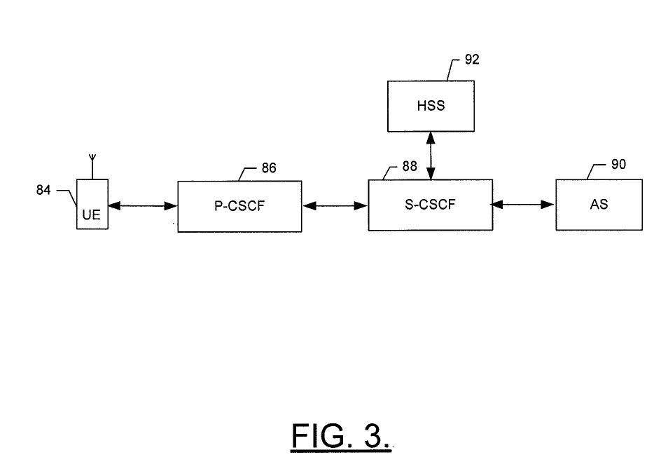

In an exemplary embodiment (e.g., for the S-CSCF of FIG. 3 below), the processing element 70 may be embodied as or otherwise control group identity provider 78. In this regard, for example, the group identity provider 78 may embodied as any device or means including, for example, software, circuitry or structure for providing group identity information 80 to other devices, which could be embodied as hardware, software or a combination of hardware and software. As will be described in greater detail below, the group identity information 80 may include one or more identity sets or groups, which may each identify alias identities, and the corresponding services supported by each identity group. In other words, the group identity information 80 may provide an identification of different sets of alias identities and the services that are supported by each corresponding set. The group identity provider 78 may be configured to provide the group identity information 80 to a user and/or an application server associated with a particular application, such as a service application that the user may initiate.

In an exemplary embodiment, the mobile terminal 10 of FIG. 1 may be an example of user equipment (UE) 84, which may be in communication with a network device such as the apparatus of FIG. 2, for example, via an IMS, such as will now be discussed in connection with the example displayed in FIG. 3. In this regard, FIG. 3 is a schematic block diagram of an IMS according to an exemplary embodiment of the present invention. As shown in FIG. 3, the IMS may include the UE 84, a proxy call session control function (P-CSCF) 86, a serving-CSCF (S-CSCF) 88, an application server (AS) 90 and a home subscriber server (HSS) 92. Although not shown in FIG. 3, the IMS may further include an interrogating CSCF (I-CSCF). The UE 84 may be in communication with P-CSCF 86 (e.g., via a Gm interface in which Gm describes a reference point between the UE 84 and the P-CSCF 86). The S-CSCF 88 and the HSS 92 may be in communication with each other via, for example, a Cx interface in which the Cx interface describes a reference point between the S-CSCF 88 and the HSS 92. The S-CSCF 88 and the AS 90 may be in communication with each other via, for example, an ISC interface in which the ISC interface describes a reference point between the S-CSCF 88 and the AS 90.

The AS 90 may be an example of a server configured to host and execute services, and interface with the S-CSCF 88 (e.g., using Session Initiation Protocol (SIP)). The HSS 92 may be, for example, a master user database that supports the IMS network entities that actually handle calls. In this regard, the HSS 92 may include subscription-related information (user profiles) and corresponding identities for use in authentication and authorization of the user. The HSS 92 in some embodiments may also provide information about the user's physical location. In an exemplary embodiment, the HSS 92 may be configured to provide the S-CSCF 88 with information related to services that are supported by a particular identity and/or the identities that may fall within a particular identity group. Each group may thus be considered to represent one set of alias identities. Accordingly, for example, the HSS 92 may provide the S-CSCF 88 with a listing of ISCIs that are supported by each identity group. Each ICSI may be, for example, a uniform resource name (URN). The S-CSCF 88 may then use the received ICSI values for each identity group to define the group identity information 80, which may be communicated from the S-CSCF 88 to other network entities. As indicated above, the S-CSCF 88 may receive the group identity information 80 from the HSS 92 as part of regular subscriber profile download during the registration phase.

The P-CSCF 86 may be, for example, a SIP proxy that is the first point of contact for an IMS terminal such as the UE 84. The P-CSCF 86 may be located either in a visited network or in the home network. The P-CSCF 86 may be configured to authenticate the user associated with the UE 84 and establish a security association with the UE 84 in order to, for example, prevent spoofing attacks and replay attacks and protect the privacy of the user. Other nodes may not need to re-authenticate the user based on the authentication performed by the P-CSCF 86.

The S-CSCF 88 may be, for example, a central node of the signaling plane. The S-CSCF 88 may, in some embodiments, be a SIP server, which may also be configured to perform session control. The S-CSCF 88 may be located in the home network. As indicated above, the S-CSCF 88 may be in communication with the HSS 92 via the Cx interface (which may use the DIAMETER protocol) to download and upload user profiles. The user profiles received from the HSS 92 may be utilized to generate the group identity information 80. In an exemplary embodiment, the S-CSCF 88 may not dedicate any storage space to long term storage of user information. As such, the S-CSCF 88 may get user information from the HSS 92. The S-CSCF 88 may handle SIP registrations, inspect messages, forward messages to an appropriate AS (based on the service associated with the message), etc. In an exemplary embodiment, the S-CSCF 88 may employ the group identity provider 78 described above in order to enable the S-CSCF 88 to provide the group identity information 80 to a user (e.g., the UE 84) and/or an application server (e.g., the AS 90) associated with a particular application, such as a service application that the user may initiate.

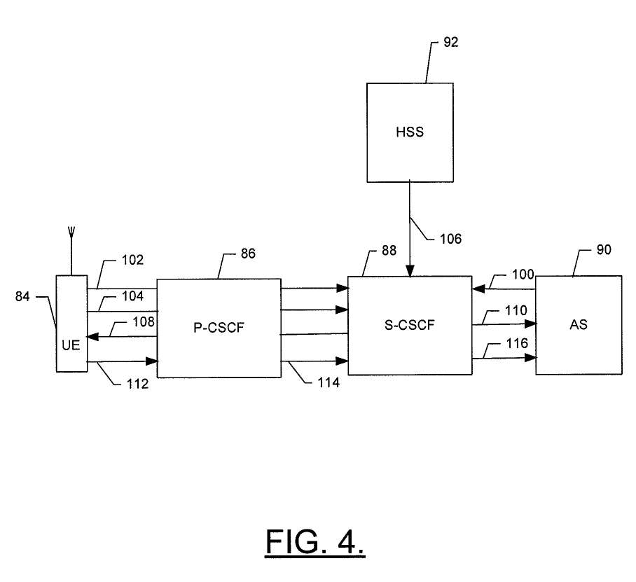

FIG. 4 is a schematic diagram showing a communication flow within the exemplary IMS of FIG. 3 according to an exemplary embodiment of the present invention. Some signals, which may be indicated as lines in FIG. 4, may be described as passing from the UE 84 to the S-CSCF 88, but it should be understood that such communication occurs via the P-CSCF 86. In this regard, as shown in FIG. 4, at operation 100, the AS 90 may subscribe for a registration event package. At operation 102, the UE 84 may register to IMS for a particular IMS public user identity (IMPU). The UE 84 may subscribe for the registration event package at operation 104, indications of which may be communicated by the P-CSCF 86 to the S-CSCF 88. The S-CSCF 88 may then download, from the HSS 92, profile information related to the subscription at operation 106. The profile information may include ICSI values for supported service for each service profile. Thus, for example, the profile information may indicate that a particular service (e.g., service A) has been provisioned to particular IMPUs (e.g., IMPU-X and IMPU-Y). However, it should be understood that such information may be provided with respect to each service for each service profile and not necessarily just for one service as indicated in the example above.

Once the S-CSCF 88 receives the profile information from the HSS 92, the S-CSCF 88 may generate the group identity information 80, which may be included, for example, as an extension to a registration event document (as described in greater detail below). The group identity information 80 may be provided to both the UE 84 and the AS 90 at operations 108 and 110, respectively. In this regard, the group identity information 80 may comprise a registration event notification including other IMPUs associated with the user and the provisioned ICSI values for each of the respective IMPUs. Thus, for example, among other things, the UE 84 and the AS 90 may be informed that service A has been provisioned for IMPU-X and IMPU-Y.

At operation 112, the UE 84 may attempt to initiate an IMS session for a particular service (e.g., service A in the present example). Accordingly, the UE 84, having the group identity information 80, may be enabled to select an IMPU that supports the particular service. Thus, in this example, the UE 84 may be enabled to select from among the available IMPUs, either IMPU-X or IMPU-Y since they both support service A. In furtherance of the current example, assume IMPU-X is selected, for example, due to a user preference or selection from among presented options. Accordingly, the UE 84 may add the IMPU-X to the outgoing request as a preferred identity as part of operation 112.

The P-CSCF 86 may authorize the identity selected by the UE 84, which may be in a preferred identity header, and may set the selected identity as an asserted identity (e.g., in an asserted identity header) communicated to the S-CSCF 88 at operation 114. The S-CSCF 88 may then execute the services based on the service profile of IMPU-X and authorize that IMPU-X is allowed to use service A. At operation 116, the S-CSCF 88 may contact the AS 90 that implements the service to be initiated (e.g., service A), based on the service profile (e.g., an iFC in the service profile). The AS 90 may receive the incoming request including the asserted identity (e.g., IMPU-X). However, in an exemplary embodiment, the AS 90 may also use the service settings of IMPU-Y for the session since the AS 90 may be aware if, for example, IMPU-X and IMPU-Y are aliases (e.g., in the same identity group).

Accordingly, embodiments of the present invention may enable a user with different public user identities to have an identity selected automatically due to the selected identity being provisioned for a particular service that the user may attempt to initiate. The enablement provided thereby to the user, may be a result of the UE 84 having knowledge of which identity groups support corresponding services via the group identity information 80. In other words, when a device logs in, a listing of which services are supported for each identity (e.g., via the group identity information 80) may enable the UE 84 to intelligently select which identity to use in response to an attempt to initiate a particular application. Meanwhile, the AS 90 may be enabled to provide different functionality for different identities based on user preference information that may be different for each identity since the AS 90 may also be aware of which identities support which services and which identities are aliases of other identities.

As indicated above, embodiments of the present invention may be implemented, for example, by providing a registration event document with extended information. An example of such a registration event document is provided below. Note that the portion labels below (e.g., portion 1 and portion 2) are merely for assisting in the explanation below.

Portion 1

<?xml version=“1.0”?>
<reginfo xmlns=“urn:ietf:params:xml:ns:reginfo”

xmlns:alias=“urn:3gpp:params:xml:ns:reginfo”
version=“1” state=“full”>

<registration aor=“sip:alice@example.com” id=“x2y”

state=“active”>

<contact id=“15” state=“active” event=“registered”

duration-registered=“1” expires=“512”>
<uri>sip:user@192.0.2.1</uri>

</contact>
<alias:gr-id-set>1</alias:gr-id-set>

</registration>
<registration aor=“sip:little_alice@example.com” id=“x2z”

state=“active”>

<contact id=“16” state=“active” event=“created”

duration-registered=“1” expires=“512”>

<uri>sip:user@192.0.2.1</uri>

</contact>
<alias:gr-id-set>2</alias:gr-id-set>

</registration>
<registration aor=“tel:+341234567890” id=“x2x”

state=“active”>

<contact id=“17” state=“active” event=“created”

duration-registered=“1” expires=“512”>

<uri>sip:user@192.0.2.1</uri>

</contact>
<alias:gr-id-set>1</alias:gr-id-set>

</registration>

</reginfo>

Portion 2

<alias:gr-id-set id=“1”>
<alias:icsi id=“1”>

<urn> urn:urn-xxx.3gpp.ims.icsi.example-telephony.version1

</urn>

<display-text> Plain Old Telephony Service </display-text>

</alias:icsi>
<alias:icsi id=“2”>

<urn> urn:urn-xxx.3gpp.ims.icsi.fancy-service </urn>
<display-text> New Fancy Service </display-text>

</alias:icsi>
</alias:gr-id-set>
<alias:gr-id-set id=“2”>
<alias:icsi id=“3”>

<urn> urn:urn-xxx.3gpp.ims.icsi.expensive-service </urn>
<display-text> Very Expensive Service </display-text>

</alias:icsi>
</alias:gr-id-set>

The first part of the example above (i.e., Portion 1) identifies identity groups or alias ID sets to thereby indicate a listing of identities associated with the user. For example, the registration event package includes the public user identities sip:alice@example.com, sip:little_alice@example.com, and tel:+341234567890. The registration event package also includes grouping information, e.g., group=1 including tel: :+341234567890 and sip:alice@example.com, and group=2 including sip:little_alice@example.com. However, it may be possible for groups to include overlapping identities in some instances.

The second part of the example (i.e., Portion 2) includes the extension provided by embodiments of the present invention. In this regard, the extension includes the service information for the groups 1 and 2. ICSI urn:um-xxx.3gpp.ims.icsi.example-telephony.version1 and urn:urn-xxx.3gpp.ims.icsi.fancy-service have been provisioned for group 1, and ICSI urn:urn-xxx.3gpp.ims.icsi.expensive-service has been provisioned for group 2. The extension also includes human readable information about the ICSIs such as if there is, e.g., a dedicated application for certain ICSI in the UE, the application may select the corresponding public user identities for this application without help from the end user. However, it may also be possible to present the human readable ICSI descriptions to the end user, and let the end user select the right public user identity, based on the service the end user is about to initiate. Moreover, it should also be understood that, in some embodiments, particular ICSI values may be repeated within some or even all of the identity groups.

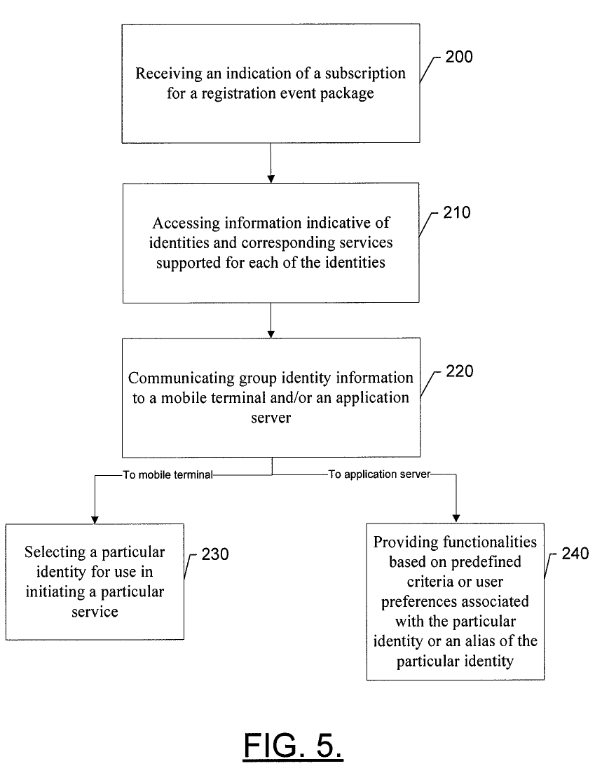

FIG. 5 is a flowchart of a system, method and program product according to exemplary embodiments of the invention. It will be understood that each block or step of the flowcharts, and combinations of blocks in the flowcharts, may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal or network device and executed by a built-in processor in the mobile terminal or network device. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that may direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, may be implemented by special purpose hardware-based computer systems which perform the specified functions or steps, or combinations of special purpose hardware and computer instructions.

In this regard, one embodiment of a method for providing group identity information as illustrated in FIG. 5 includes receiving an indication of a subscription for a registration event package at operation 200. At operation 210, the method may further include accessing information indicative of identities and corresponding services supported for each of the identities. The method may further include communicating group identity information to a terminal (e.g., a mobile terminal) and/or a network device (e.g., an application server) at operation 220. Based on the group identity information, which may, for example, identify identity groups associated with the subscription (e.g., as alias groups) and ICSI values for each respective identity group, the mobile terminal may be enabled to automatically select (e.g., without further user intervention at the time of the automatic selection) a particular identity for use in initiating a particular service, or provide options for selection of an identity to the user based on identities that support the particular service at operation 230. Additionally, based on the group identity information, the application server may be enabled to provide functionalities based on predefined criteria or user preferences associated with the particular identity or an alias of the particular identity at operation 240.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving an indication of a subscription for a registration event package;
accessing information related to the subscription and indicative of identities and corresponding services supported for each of the identities;
communicating group identity information to a terminal; and
enabling selection of a particular identity associated with initiating a particular service.

2. The method of claim 1, further comprising providing options for selection of an identity to the user based on identities that support the particular service.

3. The method of claim 1, wherein enabling the selection of the particular identity comprises enabling automatic selection of the particular identity.

4. The method of claim 1, further comprising receiving a registration to a service from the mobile terminal for a particular public user identity.

5. The method of claim 1, wherein enabling the selection of the particular identity comprises enabling the selection based on the group identity information.

6. The method of claim 5, wherein communicating group identity information comprises communicating information that identifies identity groups associated with the subscription and service identifier value for each respective identity group.

7. A computer program product comprising at least one computer-readable storage medium having computer-readable program code portions stored therein, the computer-readable program code portions comprising:
first program code instructions for receiving an indication of a subscription for a registration event package;
second program code instructions for accessing information related to the subscription and indicative of identities and corresponding services supported for each of the identities;
third program code instructions for communicating group identity information to a terminal; and
fourth program code instructions for enabling selection of a particular identity associated with initiating a particular service.

8. The computer program product of claim 7, further comprising fifth program code instructions for providing options for selection of an identity to the user based on identities that support the particular service.

9. The computer program product of claim 7, wherein the fourth program code instructions include instructions for enabling automatic selection of the particular identity.

10. The computer program product of claim 7, further comprising fifth program code instructions for receiving a registration to a service from the mobile terminal for a particular public user identity.

11. The computer program product of claim 7, wherein the fourth program code instructions include instructions for enabling the selection based on the group identity information.

12. The computer program product of claim 11, wherein the third program code instructions include instructions for communicating information that identifies identity groups associated with the subscription and service identifier value for each respective identity group.

13. An apparatus comprising a processor configured to:
receive an indication of a subscription for a registration event package;
access information related to the subscription and indicative of identities and corresponding services supported for each of the identities;
communicate group identity information to a terminal; and
enable selection of a particular identity associated with initiating a particular service.

14. The apparatus of claim 13, wherein the processor is further configured to provide options for selection of an identity to the user based on identities that support the particular service.

15. The apparatus of claim 13, wherein the processor is configured to enable the selection of the particular identity by enabling automatic selection of the particular identity.

16. The apparatus of claim 13, wherein the processor is further configured to receive a registration to a service from the mobile terminal for a particular public user identity.

17. The apparatus of claim 13, wherein the processor is configured to enable the selection of the particular identity by enabling the selection based on the group identity information.

18. The apparatus of claim 17, wherein the processor is configured to communicate group identity information by communicating information that identifies identity groups associated with the subscription and service identifier value for each respective identity group.

19. A method comprising:
receiving an indication of a subscription for a registration event package;
accessing information related to the subscription and indicative of identities and corresponding services supported for each of the identities;
communicating group identity information to a network device; and
enabling the provision of functionality based on predefined criteria associated with a particular identity.

20. The method of claim 19, wherein enabling the provision of functionality comprises enabling the provision of functionality based on predefined criteria comprising user preferences associated with the particular identity.

21. The method of claim 19, wherein enabling the provision of functionality comprises enabling the provision of functionality based on predefined criteria associated with an alias of the particular identity.

22. The method of claim 19, wherein communicating group identity information comprises communicating information that identifies identity groups associated with the subscription and service identifier value for each respective identity group.

23. A computer program product comprising at least one computer-readable storage medium having computer-readable program code portions stored therein, the computer-readable program code portions comprising:
first program code instructions for receiving an indication of a subscription for a registration event package;
second program code instructions for accessing information related to the subscription and indicative of identities and corresponding services supported for each of the identities;
third program code instructions for communicating group identity information to a network device; and
fourth program code instructions for enabling the provision of functionality based on predefined criteria associated with a particular identity.

24. The computer program product of claim 23, wherein the fourth program code instructions include instructions for enabling the provision of functionality by enabling the provision of functionality based on predefined criteria comprising user preferences associated with the particular identity.

25. The computer program product of claim 23, wherein the fourth program code instructions include instructions for enabling the provision of functionality by enabling the provision of functionality based on predefined criteria associated with an alias of the particular identity.

26. The computer program product of claim 23, wherein the third program code instructions include instructions for communicating group identity information by communicating information that identifies identity groups associated with the subscription and service identifier value for each respective identity group.

27. An apparatus comprising a processor configured to:
receive an indication of a subscription for a registration event package;
access information related to the subscription and indicative of identities and corresponding services supported for each of the identities;
communicate group identity information to a network device; and
enable the provision of functionality based on predefined criteria associated with a particular identity.

28. The apparatus of claim 27, wherein the processor is configured to enable the provision of functionality by enabling the provision of functionality based on predefined criteria comprising user preferences associated with the particular identity.

29. The apparatus of claim 27, wherein the processor is configured to enable the provision of functionality by enabling the provision of functionality based on predefined criteria associated with an alias of the particular identity.

30. The apparatus of claim 27, wherein the processor is configured to communicate group identity information by communicating information that identifies identity groups associated with the subscription and service identifier value for each respective identity group.
